(19) United States
(12) Patent Application Publication
(10) Pub. No.: US 2002/0059144 A1
(43) Pub. Date: May 16, 2002

(54) Secured content delivery system and method

(76) Inventors: Gregory J. Meffert, Convent, LA (US); Donovan Mouriz, Harvey, LA (US); Paul R. Hastings II, River Ridge, LA (US); Rick W. Wise, Lockport, LA (US); Douglas A. Laine, NewOrleans, LA (US)

Correspondence Address: SHAW PITTMAN, 2300 N STREET, N.W., WASHINGTON, DC, 20037-1128, US

(21) Appl. No.: 09/816,255

(22) Filed: Mar. 26, 2001

Related U.S. Application Data
(60) Provisional application No. 60/200,378, filed on Apr. 28, 2000.

(51) Int. Cl. H04L 9/30

(52) U.S. Cl. 705/51; 380/30; 713/156

(57) ABSTRACT

A system for and method of automatically implementing PKI-based encryption between a sender and a recipient. The system includes a sender local agent associated with a sender electronic device and a recipient local agent associated with a recipient electronic device wherein both the sender and recipient electronic devices are capable of connecting to a control server via the Internet. The sender local agent is operable to (i) receive content generated on the sender electronic device, (ii) generate a package of encrypted content using PKI-based encryption by obtaining at least one public key from the control server, and (iii) send the package to the control server. The control server is operable to receive the package from the sender local agent and transmit the package to the recipient local agent. The recipient local agent is operable to (i) receive the package from the control server, (ii) launch a recipient local agent-controlled window or process, (iii) decrypt the encrypted content in the package, and (iv) use or display decrypted content within the recipient local agent-controlled window or process. Packages preferably include content such as text, data and graphic images. Packages also preferably include embedded content dissemination rules, selected by the package sender, restricting the dissemination of the content by the recipient.

This application claims the benefit of provisional patent application U.S. Ser. No. 60/200,378, filed Apr. 28, 2000, entitled “Secured Document Delivery System.”

The present invention is directed generally to implementations of public key infrastructure (PKI) based encryption and specifically to harnessing the advantages of PKI to provide encryption of and controlled access to data including, but not limited to, email, email attachments, streaming media, XML along with other transaction formats, and wireless communication data.

### BACKGROUND

One of the challenges of the Internet, whether for transmitting sensitive email (with or without attachments), for conducting electronic commerce, for implementing bill presentment schemes or for carrying out content publishing, is the risk of having the documents or electronic/digital content fall into the wrong hands, or be used in an unauthorized way. While the use of the Internet for the uses mentioned above has been growing steadily over the last few years, one major obstacle to truly explosive growth is the lack of actual or even perceived security. For example, attorneys are reluctant to send sensitive documents over the Internet as email attachments as they could be intercepted. Likewise, consumers are hesitant to purchase items over the Internet using their credit cards as these numbers could be diverted and used fraudulently. Additionally, magazine publishers, recording companies and content producers in general have failed to fully exploit the leverage the Internet provides because once the content is published over the Internet it is available in digital form and easily copied without the knowledge (or permission) of the author or publisher, thereby depriving the content producer of revenue. The idea of protecting digital content that is transmitted over an electronic network or is otherwise conveyed electronically from one party to another is often referred to as “digital rights management” or DRM. Unfortunately, widely accepted DRM standards have yet to be adopted by the public at large and thus the potential of the Internet as a content distribution medium has yet to be fully attained.

In addition to the desire to secure documents and content that are transmitted via the Internet, there is also a need for identity authentication. In the physical world, photo IDs and handwritten signatures are used to ensure that a person is who he or she claims to be. The Internet, however, is a relatively anonymous world, making it hard to know who is at the end of a network connection. To address the foregoing issues, namely, content security and identity authentication, various methods have been devised including digital signature and encryption techniques. Known methods of encryption offer different advantages and disadvantages such as the speed of the encryption and decryption process and how safe the encryption actually is.

For example, though not originally designed for Internet use, electronic data interchange (EDI) was developed to provided computer-to-computer exchange of business documents between companies. In some implementations, hand shaking protocols and encryption are used to confirm that the sender and recipient are indeed who they allege to be. EDI is now used extensively over the Internet. Unfortunately, for the casual Internet user or a user that is not concerned with purchase orders, shipping documents, invoices and invoice payments (document types for which EDI was originally developed), the protocols that are used for EDI are not particularly useful. More importantly both the sender and recipient must have computers and software that understand the unique EDI protocols to communicate via EDI.

Another means to increase authentication and security of digital data over electronic networks and establish identity authentication is public/private key infrastructure (PKI). PKI is a global, de-facto standard that uses symmetric and asymmetric encryption and digital certificates to achieve secure Internet services. In practice, PKI systems use a matching pair of encryption and decryption keys. A “public” key is available and known to everyone, while a “private” key is secret-and accessible only by the user. In a PKI system, a certificate authority (CA), a widely trusted organization established to assure trust, issues electronic credentials called digital certificates, using a standard such as the International Telecommunications Union (ITU) standard X.509. With the electronic digital certificate, the user and his public key are identified, much like a photo ID in the physical world. The two keys combined-along with a digital signature-offer undeniable proof of the sender's identity, and the fact that the document has been delivered unaltered. Combining the concept of a digital certificate with PKI keys results in an infrastructure for electronic identification, and secure electronic communication (for business or any other use). Unfortunately, implementation of PKI systems like that just described is usually a very expensive proposition and presently is undertaken only by relatively large corporations that are able to afford it.

Pretty Good Privacy, commonly known as “PGP”, is a “stripped-down” version of a PKI system and has become popular even among some casual users of the Internet. The benefit of PGP is that while it is relatively easy for a single user to set up, it still provides the user with one of the best encryption schemes available, namely, public/private key encryption. PGP is primarily designed to secure e-mail and to digitally sign documents and is probably the most common encryption program in use due to its ease of implementation and the fact that no explicit infrastructure is required. While PGP is easily setup compared to a traditional PKI model that a large corporation might implement, PGP can sometimes be awkward to use and, more importantly, is less robust when it comes to issues like digital certificate creation, management, automated key issuance and retrieval, authentication and trust. Specifically, in PGP there are no certificates, CAs, or strong authentication. Thus, PGP is only a limited solution to security issues on the Internet.

Web browsers operating in conjunction with the World Wide Web also offer a level of security embodied in Secure Socket Layer (SSL). SSL is an Internet protocol that encrypts all of the communications between a web site and a client. This method of making a web site secure uses multiple methods of encryption and relies on certificates to authenticate a web site's identity. For these reasons, and the ease by which SSL can be implemented, SSL is the encryption protocol currently used to encrypt Internet credit card transactions.

Another example of the use of SSL is described in U.S. Pat. No. 5,790,790, which discloses a system for delivering an electronic document using HTTP to “push” a document to a remote server. The remote server, upon receipt of the document, notifies an intended recipient of the document that the document has been received and that the recipient can then download the document using local protocols. Because, in accordance with the '790 patent, the document is being transmitted using HTTP, SSL is implemented to achieve a minimum level of security.

Among the various methods of document security and identity authentication, EDI and full-scale PKI can be considered the most robust EDI and full-scale PKI are, however, generally difficult to use and implement. Conversely, smaller scale encryption systems such as PGP and web-based security schemes like SSL may be more simple to implement, but these smaller scale encryption systems cannot offer the level of security or identity authentication that the more robust PKI systems can. Thus, there continues to be a need for systems and methods that provide robust security and identity authentication with respect to content delivered over the Internet while, at the same time, being relatively simple to use.

Moreover, there is still a need for a system and method for secure digital rights management. In particular, there continues to be a need for establishing security and control over electronic content that is intended to be published over the Internet in order to maintain valuable rights in the content.

Further still, there remains a need for simple and secure bill presentment systems and methods so that vendors and service providers can replace conventional bill mailings with an electronic system that is accurate and secure.

### SUMMARY OF THE INVENTION

It is therefore an object of the present invention to provide a simple and robust implementation of PKI encryption with no or little intervention by a user.

It is also an object of the present invention to provide an implementation of PKI-based encryption that separates, functionally, local or front end functions and server side or back end functions.

It is still a further object of the present invention to provide an implementation of PKI-based encryption in which local and back end portions of the encryption system automatically communicate with one another without user intervention.

It is an object of the present invention to provide a system and method of PKI-based encryption that operates with existing email client applications.

It is also an object of the present invention to provide encryption and control for the life of content that is encrypted in accordance with the principles of the present invention.

It is also an object of the present invention to provide a system and method for effecting, in online and offline environments, full digital rights management with respect to any content that is in electronic form and is conveyed via the Internet.

It is also an object of the present invention to provide a system and method for providing security and authentication among businesses, and in particular application-to-application securing and authenticating.

It is still a further object of the present invention to provide a system and method of PKI-based encryption in which keys are automatically transferred to a party, device or system requiring such keys.

It is also an object of the present invention to provide a system and method for delivering electronic content from a sender to a recipient using the Internet, wherein the recipient is notified that content is awaiting pickup using a notification means other than the Internet.

It is yet another object of the present invention to provide a system and method that permits a sender of content to establish content viewing privileges that cannot be altered by the viewer.

It is also an object of the present invention to provide a system and method of PKI-based encryption in which content that is delivered to a recipient remains in an encrypted state except when viewing or otherwise using the content for its intended purpose.

It is also an object of the present invention to provide a system and method of PKI-based encryption in which a control server controls the passing of content between sender and recipient and/or controls the viewing or use of content by a recipient.

It is also an object of the present invention to provide a system and method of PKI-based encryption in which a local agent, in conjunction with an application specific interface, stores private and public keys that are used to view or use content.

It is still a further object of the present invention to provide a system and method in which content that is transmitted from a sender includes permanent embedding of user access, distribution rights and transaction history.

It is also an object of the present invention to provide a system and method that effects PKI-based encryption that includes a local agent that is operating system independent and can communicate with a control server that is accessed via the Internet.

It is also an object of the present invention to provide a PKI-based encryption system and method that automates identity authentication.

It is also an object of the present invention to provide a system and method of receiving encrypted content that is decrypted within an environment controlled by an applet.

These and other objects of the present invention are achieved by providing an Internet-based PKI-based encryption system and method that sends data such as documents, email, music files, XML content, etc., (hereinafter “content”) easily and securely, with the minimum possible user intervention. In accordance with an important aspect of the present invention, the system provides life-of-content security, i.e., the system controls use of the content even after it has been sent or conveyed, with a full menu of restrictions including, for example, “do-not-print-or-forward” and “self-destruct.” Accordingly, even if a computer or device on which the content is stored were stolen or fell into the wrong hands for even a limited amount of time, the content that has been encrypted in accordance with the present invention remains secure and readable only by the intended recipient. In the following description a “recipient” is meant to include anything that receives content. Thus, a person as well as electronic devices and electronic processes are considered recipients within the context of the present invention.

In accordance with the present invention, a full PKI-based encryption system is implemented within a company network, or hosted by one or more servers accessible via the Internet. Specifically, a user can join a Certificate Authority (CA) managed by the present invention, which is implemented as a global trusted hierarchy, or, a user can associate, or cross-certify, his existing PKI environment via, for example, linked Lightweight Directory Access Protocol (LDAP) directories, such that the existing Certificate Authority (CA) and PKI environment becomes a trusted entity within the PKI environment of the present invention.

Still further in accordance with the present invention, all aspects of PKI management are preferably performed on behalf of the user without, or with very little, user intervention. More specifically, identity authentication, certificate issuance, key generation (when needed) and certificate revocation list (CRL) management and recycling are all accomplished, substantially automatically, by the present invention. In addition, the present invention provides a certificate repository, certificate revocation, key backup and recovery (e.g., in case a user forgets his or her password), support for non-repudiation of digital signatures, management of key histories, and support for cross-certification. More specifically, various interrelated components of the present invention are provided to generate symmetric keys, authenticate identities (digital signature authentication), implement audit logging, in concert with a certificate management service that provides certificate issuance, revocation, and recovery. In addition, a local agent can retrieve appropriate private and public keys from different CA's simultaneously to automate cross-certification.

In accordance with the present invention, access and protection of content stays firmly under the control of the user (sender or recipient, as the case may be), for the life of the content. Once encrypted, the content stays secure, e.g. encrypted, for its entire “life” and since, in accordance with the present invention, only the recipient of the content has the appropriate key, only the recipient can gain access to that content to the extent permitted by the party that conveyed the content to the recipient in the first place.

In an important aspect of the present invention, the PKI and either the provided CA or integration module to an already existing CA provided by the present invention operates seamlessly with e-mail applications, business applications, web browsers, wireless and PDA devices, music players and similar electronic devices that might store and/or forward digital content, including electronic books, wallets and the like. Significantly, all of the applications just described function virtually identically to how they function without the implementation of the PKI of the present invention. Accordingly, users of such applications and devices need not learn the complexities of PKI, but rather can simply benefit from a PKI's protection.

The present invention comprises two main components: (1) a local agent, in conjunction with an application specific interface (ASI) (sometimes referred to herein collectively as the local agent), and (2) a control server, which, when required, is in communication with the local agent using http (or FTP) via the Internet. It should be understood by those skilled in the art, however, that these two components can function independently or in combination to achieve the objectives of the present invention. That is, the present invention is directed to these components independently and in combination. The local agent/ASI combination preferably is a transparent, operating system (OS) independent application that operates in conjunction with a pre-selected application such as an email client, media player, or business application process. For example, the local agent makes it possible for a user to operate existing messaging software applications in substantially their conventional way, yet provides the necessary integration to employ PKI-based encryption using that messaging software application. The primary functions of the control server, on the other hand, are to receive messages and encrypted content from the local agent, access appropriate PKI support components, pass messages and content back to the local agent, initiate audit trails, and transmit to an intended recipient. To accomplish these tasks, the control server preferably has access to, among other functional units, both application services functionality and PKI certificate and management processes.

PKI-based encryption is an inherently closed system. That is, when a sender encrypts with a recipient's public key and signs with his own private key, it is assumed that the sender has the recipient's public key and that the sender and intended recipient are affiliated with the same certificate authority. This closed system/process has always been at the cornerstone of PKI encryption. Indeed, PKI-based encryption functionality cannot be attained without having both parties communicating within this closed system. Unfortunately, it is not always the case that everyone subscribes to or is affiliated with the same certificate authority. Historically, this has been one of the most difficult hurdles to overcome to achieve widespread use of PKI-based encryption.

The present inventors studied this problem and have identified a solution to make PKI-based encryption available in a simple and seamless way. More specifically, the present inventors have identified what can be described, primarily, as “back office” functions such as certificate management, issuance, recycling, and key management. Likewise, the present inventors have identified those functions that can be described, primarily, as “front office” or execution and integration functions. In accordance with the present invention, the so-called back office functions are loaded or controlled from the control server, while the integration functions are aggregated and embodied in the local agent/ASI. In other words, in accordance with the present invention, the functionality of a classic, well-conceived and “bulletproof” security process (i.e., PKI-based encryption) is reorganized and separated into back office functions (the control server and/or units in communication therewith) and execution and integration functions (the local agent). These physically separated functions operate in conjunction to achieve full PKI-based encryption, digital signature authentication, and digital rights management in a seamless and efficient manner.

Overall, the present invention is a robust combination of software routines, private/public keys and digital certificate management services, encryption and technological design to create a unique, effective, and easy-to-use tiered system and method of transmitting and receiving sensitive information (data) via the Internet. Once the information is encrypted, that is, formed into a wrapped package in accordance with the present invention, the wrapped package (or encrypted content) is sent either to the control server, or directly to another local agent in a “peer to peer” fashion. The control server controls all security, authentication, tracking, confirmation, and archival of all such encrypted content, thereby providing an increased layer of security and monitoring.

In accordance with a significant feature of the present invention, the encrypted content maintains its encrypted form throughout its “life.” Thus, when encrypted content is received by a recipient's local agent, the local agent decrypts all or part of the package (encrypted content) based on proper key access, and preferably lists the content as though it were a conventionally received email (e.g., into MICROSOFT OUTLOOK or LOTUS NOTES), downloaded music file (e.g., an MP3 file), business transaction (e.g. an XML file), or any combination thereof. The local agent also processes the “wrapper” associated with the encrypted content (package) to control forwarding or other dissemination possibilities. After use, the decrypted content is preferably destroyed preventing other, non-authorized persons or processes, from seeing, using or playing the data. Thus, even after content is received by the recipient, the further dissemination of the content can be controlled in accordance with the sender's wishes.

In accordance with an implementation of the present invention, a recipient of encrypted content can be notified in one or more of several different ways including e-mail, fax, phone, cell phone, pager, or other wireless device.

In another important aspect of the present invention, the sender of the encrypted content controls the proliferation of the content. Via menu-driven restrictions, the sender can dictate whether the content can be printed, whether it can be forwarded, how many times it can be viewed or listened to, and whether it should self-destruct, i.e., permit viewing (listening) one time only, after one or after a predetermined number of uses.

It is conceivable that some intended recipients of content that is encrypted in accordance with the present invention will not have, and do not intend to load a local agent/ASI in their electronic device. In such cases, the present invention still provides a means by which the intended recipient can receive encrypted content that still carries the sender's desired dissemination rules. More specifically, when it is detected that an intended recipient is not a registered user of the system of the present invention, or does not have a local agent/ASI installed, the intended recipient preferably receives a notification email, for example, that includes a link (URL) to a web server. When that link is established an applet is preferably downloaded and executed to the intended recipient's web browser or HTML enabled email client. The applet, preferably written in an operating system independent language such as JAVA, and preferably executing within the browser “sandbox” to avoid any installation issues, includes the decryption functions that a local agent would normally include. Moreover, the applet, like the local agent of the present invention, fully controls the window in which the content is viewed, whereby copying and other editing functions are precluded, even when presented inside the web browser or email client. If the encrypted content was originally generated as an email with an attachment, the attachment is preferably converted to a multi-page TIFF or JPEG file that is itself encrypted, before being sent to the applet. Accordingly, even if an intended recipient does not have a local agent, the principles of the present invention (e.g., life-of-content control) can still be implemented.

In an alternative embodiment, the local agent/ASI may actually be embedded to the encrypted content.

### BRIEF DESCRIPTION OF THE DRAWINGS

Other objects and advantages of the present invention will be apparent from the following description taken in connection with the accompanying drawings wherein:

FIG. 1 is a schematic diagram illustrating an exemplary system for practicing the principles of the present invention;

FIG. 2 is a flowchart illustrating an exemplary content creation and sending process in accordance with the present invention;

FIG. 2A is an exemplary illustration of the positioning of specially provided button and menu selection within an email application in accordance with the present invention;

FIG. 3 depicts an exemplary dialogue box for selecting level of security and content dissemination rules in accordance with the present invention;

FIG. 4 is a flowchart illustrating an exemplary content reception and viewing process in accordance with the present invention;

FIG. 4A is an exemplary illustration of a local agent-controlled content viewing window in accordance with the present invention;

FIG. 5 illustrates a bill presentment and high-volume component architecture in accordance with the present invention;

FIG. 6 illustrates how the standard or current MP3 file format may be modified in accordance with the present invention;

FIG. 7 depicts a process for generating the modified MP3 file layout or format illustrated in FIG. 6; and

FIGS. 8-10 illustrate an exemplary decryption process for encrypted MP3 files in accordance with the present invention.

### DETAILED DESCRIPTION OF THE INVENTION

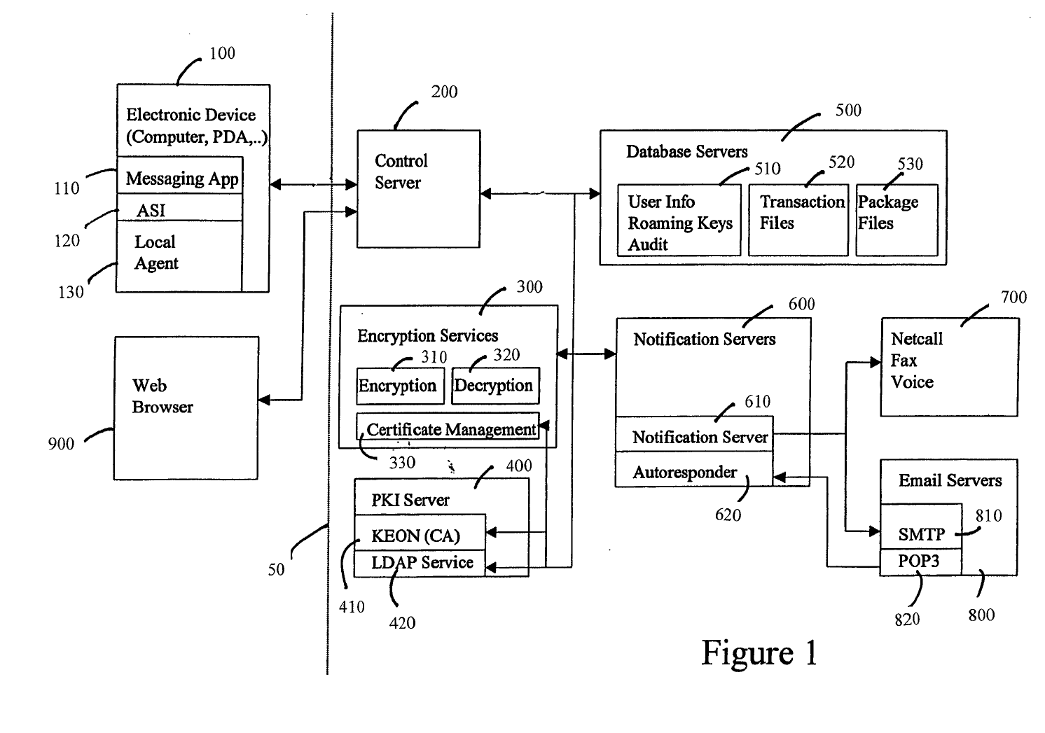

FIG. 1 is a schematic diagram illustrating an exemplary system for practicing the principles of the present invention. One important achievement of the present invention is providing simple and accessible PKI-based encryption to users who or processes that might not otherwise implement a robust encryption scheme such as PKI due to the difficulty of its use or its integration issues. The present invention overcomes these issues by splitting the PKI process between front end (i.e., local) functionality and back end functionality. In accordance with the present invention these functionalities are combined seamlessly, from the user's or process's perspective, by employing the capabilities of the Internet to automatically pass messages, keys, authorization and content between the front and back end processes.

The following description of the present invention is directed, primarily, to implementing PKI-based encryption in an email application such as LOTUS NOTES or MICROSOFT OUTLOOK. A latter part of this specification outlines how any form of content, e.g., a bill, statement, business transaction, an audio file or other streaming media, can be encrypted and controlled by implementing the principles of the present invention.

Referring to FIG. 1, an electronic device 100 such as a personal computer or personal digital assistant (PDA) includes a messaging application 110 such as LOTUS NOTES, MICROSOFT OUTLOOK or any number of other email clients. Also loaded on electronic device 100 is a local agent 130 that is able to automatically communicate with messaging application 110 via application specific interface (ASI) 120. ASI 120 preferably is a collection of software code that is written using tools made available by messaging application 110 in order to externally control messaging application 110. This software code preferably relies on “hooks” and like software functions which the messaging application itself makes available to software developers. For instance, many messaging applications come with a so-called “software developer's kit” that permits a software developer to configure and customize the messaging application's functionality including, for example, its graphical user interface.

Local agent 130 preferably comprises code (e.g., scripts and dynamic link libraries (DLLs), or Java archive files or libraries (JAR files) ) that, via ASI 120, configures messaging application 110 and enables a user to seamlessly access the so-called “back office” functionalities of the present invention. More specifically, local agent 130 preferably enables electronic device 100 to connect to control server 200, to request a certificate and to encrypt and decrypt wrapped content, which will all be explained in more detail later herein.

The following modules preferably make up local agent 130 for the LOTUS NOTES email application:

| | |
|---|---|
| (a) LocalAgent.d11 | this module includes core local agent |
| | functionality including accessing message body |
| | text, attachment, and other message related |
| | information from the Lotus interface. |
| (b) Config1.exe | this is a “wrapper” for LocalAgent.d11 and |
| | pulls up configuration dialog and facilitates |
| | configuring of proxy settings to enable local |
| | agent 130 and electronic device 100 to use their |
| | connection to the internet; |
| (c) Conwiz.scp | this module includes the IP addresses of control |
| | server 200; |
| (d) Conwizard | this is a connection wizard that configures |
| | connectivity to control server 200 using |
| | browser settings; |
| (e) InstallScripts.exe | this module installs Lotus Scripts into the |
| | user’s mail database that allow Lotus Notes |
| | to access the LotusPluginD11.d11; |
| (f) Lcppn201.d11 | this is the Lotus Notes CPP API runtime file. It |
| | is required so that LotusPluginD11.d11 can |
| | access the user mail database; |
| (g) LotusPluginD11.d11 | this is the LOTUS ASI 120 and provides |
| | communication between the LOTUS Notes |
| | database and local agent 130; |
| (h) Nnotes.d11 | This is the Lotus Notes CPP API runtime |
| | file. It is required so that LotusPluginD11.d11 |
| | can access other Lotus mail functions. |
| (i) PackageEncrypt | this module encrypts packages (i.e., content) |
| | using RSA algorithms; |
| (j) SessionEncrypt | this module performs RSA client/server session |
| | encryption, i.e., between local agent 130 and |
| | control server 200; |
| (k) Transport.d11 | this module provides HTTP transport layer |
| | communications from local agent 130 |
| | to control server 200 (also incorporated into |
| | LocalAgent.d11) |

Although the foregoing modules are identified separately, those skilled in the art will appreciate that the different functions described can be combined or grouped together in any number of ways depending on software developer preferences and code efficiencies.

As shown in FIG. 1, local agent 130 is in communication with control server 200 in order to access the so-called back office functions that are implemented, generally, with elements 300, 400, 500, 600, 700 and 800, the details of which are described below. Control server 200 in combination with components connected to it enable local agent 130 to access the PKI-based encryption services provided by the present invention. The collection of back office components (to the right of dotted line 50 in FIG. 1) manages connections, and directs service requests to the appropriate component for service execution. For example, control server 200 preferably is in communication with an LDAP directory service 420 via PKI server 400 to retrieve a user's signing and encryption keys to provide to a local agent 130, and is further in communication with database servers 500 to access appropriate user login and package information.

In this regard, control server 200 preferably includes the following modules:

| | |
|---|---|
| (a) com.control.logging | an event logging module that handles all the |
| | logging of events and exceptions into a |
| | database 520. |
| (b) com.control.node | this is a process controller module that |
| | controls all the subnode processes that |
| | are being executing (e.g., notification, |
| | application services, auto responder). |
| (c) com.control.security | this module provides sessions security. |
| | That is, it manages connection security in that |
| | it handles connection to a |
| | SessionJavaWrapper.DLL. This module is a |
| | wrapper class that marshals the data |
| | between the Java Native Interface and |
| | The SessionEncrypt.D11 which uses Diffey- |
| | Helman Key agreement to secure access. |
| | Connection security implemented between |
| | control server 200 and local agent 130. |
| (d) com.control.server | this module functions as a connection |
| | manager which listens for connections on a |
| | predetermined port (e.g., port 80) and handles |
| | each connection and request as it comes in. In |
| | other words, this module handles the initiating, |
| | executing and terminating of connections |
| | between control server 200 and local agent 130. |
| (e) | this module is a service director that |
| com.control .server.edoc | handles the uploading and downloading of files |
| server | and encrypted content, manages interactions |
| | with LDAP service 420 to retrieve signing and |
| | encryption keys for local agent 130, manages |
| | database connections (e.g., to database servers |
| | 500), stores encrypted content in appropriate |
| | databases, manages password and key |
| | agreement exchanges, and generally |
| | handles HTTP exchanges for control |
| | server 200. |
| (f) | this module manages the interactions |
| com.control.server.edoc | and data representations for each session that |
| server.session | is initiated with control server 200. |

Each of the individual components identified as back office functions will now be explained in further detail. Encryption services 300 comprises encryption routines 310, decryption routines 320 and certificate management routines 330. Encryption routines 310 provide services for the encrypting of data sent to local agent 130 from control server 200 using, preferably, a 128 bit session key. Decryption services 320 provide the facilities to decrypt the communication data received from local agent 130 using a 128 bit session key.

PKI server 400 is accessed when a certificate (e.g., a certificate in accordance with the X.509 standard) is necessary to implement encrypted communication. PKI server 400 preferably can generate its own certificates via CA 410 or can employ LDAP directory Service 420 to acquire certificates or keys from other certificate authorities, as desired. All such functionality, in accordance with the present invention is accomplished absent any express direction from a user of electronic device 100, except to the extent that the user or process has indicated a desire to employ PKI-based encryption that is made available through the implementation of the present invention, or to the extent that the content that the user desires to view (use) is accessible only by first obtaining necessary keys and/or certificates.

Similarly, local agent 130, when necessary, automatically notifies CA 410 of public key(s) required. Local agent 130 then retrieves the appropriate key(s) across an encrypted connection (e.g., SSL), and then executes a signing algorithm with a private key on the content. On the recipient side, the same process occurs except that a signature authentication algorithm is executed using the appropriate public key.

Database servers 500 comprise several databases that are accessed on an as-needed basis by control server 200 or other components of the present invention to maintain the automatic and seamless implementation of PKI-based encryption. Specifically, there is preferably included a user information, roaming keys and audit database 510, a transaction files database 520 and a wrapped content database 530. Database 510 stores information related to individual users and keys that can be used by those users in the event the user is not operating from an electronic device that has a local agent 130 installed. Transaction database 520 preferably records each instance of wrapped content that is handled by control server 200 so that a full listing of the operation of the system may be generated as desired. Finally, wrapped content database 530 stores interim copies of wrapped content that is en route to a final recipient. Transaction database 520 and audit database 510 may be accessed and updated from initial package creation to post-reception. Wrapped content database 530 is accessed and updated upon package creation and download.

Notification component 600 preferably comprise a notification server 610 and an autoresponder server 620. Notification server 610 is preferably in communication with a netcall server 700 that can notify an intended recipient that wrapped content is awaiting their pick up. Such notification preferably includes notification via the Internet, facsimile, and/or voice circuits, which ever might have been previously selected by a user. In addition, and preferable in the case of an email implementation, the recipient is notified that wrapped content is awaiting via email server 800, and in particular SMTP 810. In the event of an erroneously addressed email, the email server's POP3 820 triggers autoresponder server 620, which alerts control server 200 that an email has not been properly delivered and to take corrective action, namely, pass a notification back to the appropriate local agent 130.

The operation of the present invention will now be described in the context of an email application, namely, LOTUS NOTES. It should be noted that the process is similar for all forms of digital content described herein. As already noted, the present invention provides a means for users of an email application such as LOTUS NOTES to send and receive secure electronic messages, “wrapped content” or “packages” with advanced control over the message's ultimate disposition. Recipients preferably receive their message securely through various means including another email application supporting the functionality of the present invention. In accordance with the present invention, content is strongly encrypted before leaving its origin. The encrypted or wrapped content is transmitted in that form and stored in that same encrypted format on the recipient's electronic device (e.g., his computer). Disposition or dissemination rules are also preferably wrapped within the content. These rules wrapped with the content are set by the content sender and, preferably, can only be deciphered by local agent 130 and, when necessary, control server 200. For example, the sender may elect to have content viewed only once and/or set authentication options for a recipient whereby the local agent on the recipient's computer will permit viewing of the content one time only and/or will require predetermined sign-in requirements which results in robust authentication.

Generally, the intended recipient is notified when content is awaiting pickup. While a recipient need not be a subscriber of the back end functionality provided by the present invention, receipt of the content may be authorized only if the recipient first registers with the back end functionality, namely, the appropriate user database. In a preferred embodiment, when the recipient downloads the content as well as when he views or uses the content, the sender is preferably notified.

A more detailed description of the foregoing process follows. If a user does not presently have the appropriate local agent 130 and application specific interface 120 already loaded on his computer, then, that user must first connect with control server 200, optionally identify themselves through a registration process, and obtain the “front end” or integration components preferably including a personal digital certificate, i.e. local agent 130 and ASI 120 (or a combination thereof). In particular, the installation wizard of the present invention, available via control server 200 over the Internet, installs the necessary script code that calls the local agent from within the standard LOTUS NOTES menu. Then, the connection wizard automatically runs and determines a method whereby the machine on which local agent 130 is being loaded can connect with control server 200. At this point, local agent 130 prompts the user for a certificate passphrase. Control server 200 then verifies logon and the certificate passphrase using, preferably, an SSL connection. Local agent 130 then encrypts the logon password and stores the passphrase in a registry that is not accessible to the user. In addition, the certificate passphrase is preferably hashed and stored in the user's certificate profile in database 510. At this point, the local machine, i.e., computer 100, holds a complete user profile, including validated, hashed certificate passphrase and private keys encrypted with the user's certificate passphrase. A secured environment now exists for offline access to encrypted content. Logon password and certificate passphrase can be validated against the registry and the user profile. The passphrase is required to access the private key to permit decryption of the encrypted content.

Once the one-time setup procedure is complete, the user is ready for subsequent online or offline sessions to send and receive encrypted content.

Thus, for transmitting a new encrypted message, a LOTUS NOTES user preferably composes an email message as is conventional. Files may be attached to the email message as well. Then, instead of clicking on the traditional “send” button provided by LOTUS NOTES, the user preferably clicks a specialized button, provided by the present invention via the InstallScripts.exe module, thereby launching the PKI-based encryption services. At this point local agent 130 saves the email message to the LOTUS NOTES database and launches a login procedure to control server 200. The user is then prompted for and then enters authentication information (e.g. a pass phrase or biometric identification) and the memo (email message) is encrypted using PKI cryptography. That is, the email and/or any attachments is encrypted using CAST-128 and optionally signed using a certificate based SHA-1 signed MD5 hash value to create a “package.” This package is then transmitted to control server 200 via http or ftp, preferably using an SSL connection. Waybill information affirming the complete, uncorrupted transmission of the package is subsequently transmitted to the LOTUS NOTES application. A globally unique tracking number is then assigned to the package and it is stored, for example, in database 530. Finally, the “sent” database in LOTUS NOTES is updated to indicate that an email has been sent.

The recipient of the package, assuming he is already a registered user of the present invention, is notified of an awaiting package by the means he has previously selected, e.g., facsimile, telephone, pager and/or email-based notification. If the intended recipient is not a registered user of the present invention then the recipient is sent an email message containing either (1) sign-up information for a new account or (2) a URL that will take that recipient directly to view the encrypted content, upon verifying recipient credentials, using an SSL connection.

For a typical recipient who also happens to be a LOTUS NOTES application user, for example, the following reception process occurs. After being notified of an awaiting package, the recipient selects a special receive button (provided via ASI 120) within the LOTUS NOTES graphical interface. After being prompted for and entering authentication information, local agent 130 automatically connects to control server 200 via http or ftp. The awaiting package, or encrypted content, is then sent from database servers 500 to local agent 130 and, ultimately, the content is stored, encrypted, on device 100. In a preferred embodiment of the present invention, an email is also sent to the original sender notifying the sender that the package has been received by the intended recipient. Once the package is stored on device 100, a status information memo (entry) is created in the appropriate LOTUS NOTES database (e.g., “inbox”). The status information memo (entry) includes a brief message identifying the subject, sender and tracking number of the package. Thus, to view the contents of the package, the recipient simply double clicks on the entry in the LOTUS NOTES “inbox” database. This causes local agent 130 to launch a viewer (preferably a separate window controlled by local agent 130) within which the encrypted content including any attached files are decrypted and, thus, viewed. The local agent automatically prompts the recipient for any required passphrase and automatically retrieves any keys necessary to view the encrypted content that is the subject of the email. Such key retrieval might include automatic communication with control server 200 to obtain keys via CA 410 or LDAP server 420. In accordance with the present invention, even after the local agent-controlled viewer (window) is exited, the content that was just viewed remains encrypted on the recipient's machine.

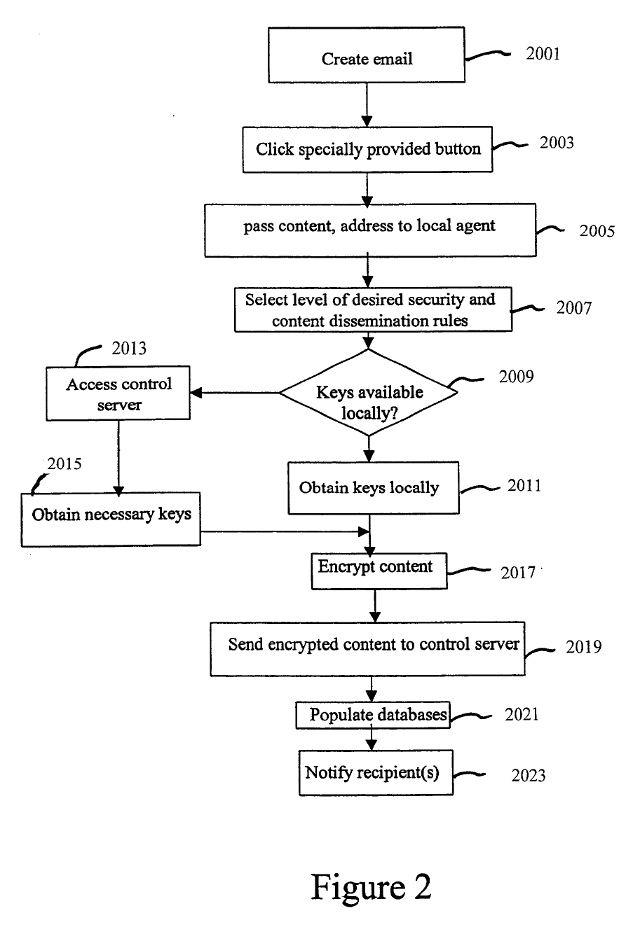

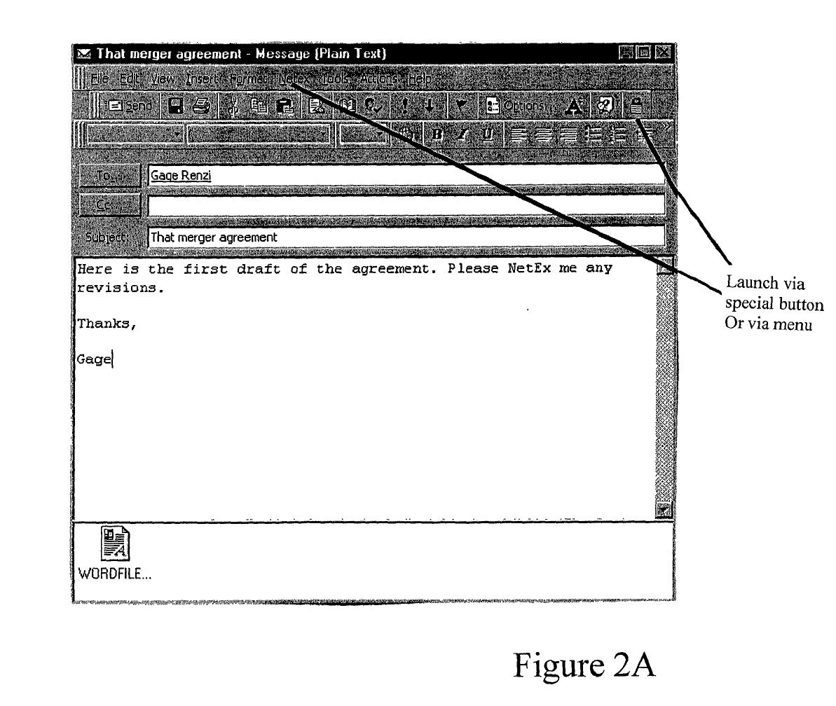

FIG. 2 is a flowchart depicting an exemplary process in which an email is created and forwarded via control server 200 to a recipient. At Step 2001 an email is created within a messaging application such as LOTUS NOTES. Then at Step 2003, instead of clicking on the conventional “send” button, a special button is provided within the graphical user interface, and this button is clicked to launch the encryption mechanisms provided by the present invention. FIG. 2A is an exemplary illustration of the positioning of the specially provided button or a menu category within an email application in accordance with the present invention.

At Step 2005 application specific interface (ASI) 120 passes the content of the email and address information to local agent 130. At Step 2007 local agent 130 prompts the user to select a level of desired security for the encrypted content and content dissemination rules. (This aspect of the present invention will be discussed in further detail below.) Local agent 130 then determines at Step 2009 if the appropriate encryption keys are available in local registries (within the local agent). If local registries do contain the necessary keys, then at Step 2011 those keys are fetched. If the appropriate keys are not available locally, local agent 130 accesses control server 200 via, preferably, an SSL connection at Step 2013. Then at Step 2015 local agent 130 requests and obtains the necessary keys from control server 200 (which itself accesses PKI Server 400 or encryption services 300, as required). Once the keys are obtained via either Step 2011 or Step 2015, the email content is encrypted with the appropriate keys at Step 2017. Also at this step, the desired level of security and content dissemination rules are preferably wrapped with the encrypted content (details of this feature of the present invention are discussed below). The encrypted content (or, alternatively, the wrapped content or package) is then sent, at Step 2019, to control server 200, preferably, via an SSL connection whereupon, at Step 2021, the appropriate databases 510, 520, 530 are preferably populated as described above by database servers 500. Finally, at Step 2023 the intended recipient of the encrypted email is notified via notification servers 600 in conjunction with component 700 and/or email server 800. Thus, except for clicking on a specially provided button, the sender exploits the robust security and authentication features of PKI-based encryption in a fully automated manner.

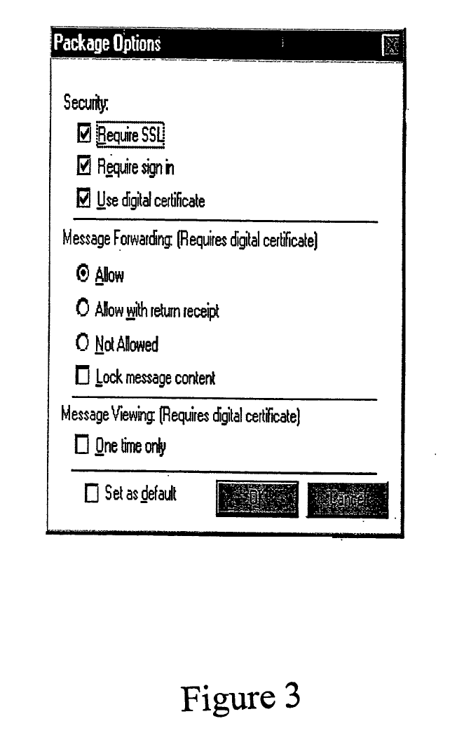

Not only does the present invention provide public key infrastructure based encryption in a seamless and user friendly manner, but the present invention further provides a life-of-content feature which permits a sender or creator of content to control the dissemination of that content even after it has been delivered to intended recipients. Referring to FIG. 3, the menu illustrated is preferably presented to a content creator at, e.g., Step 2007 of FIG. 2. Specifically, a number of options can be assigned to each package or encrypted content that is individually acted upon by the creator and present invention. As shown, there are three distinct levels of “security” that can be chosen. First, SSL can be required in order for a recipient to be permitted to view the package. Second, a sender or creator can require that the recipient sign into control server 200 of the present invention using a password. Finally, the sender can also require that the recipient use a digital certificate (including necessary passphrase) in order to view the package materials. Such a certificate ensures proper authentication. In this final case, the certificate management services 330 of the present invention may be employed to provide the appropriate certificate.

Content dissemination is also controlled by the creator or sender in accordance with the present invention, resulting in robust digital rights management capabilities. The control of content dissemination is effected using the options labeled “Message Forwarding” and “Message Viewing” in FIG. 3. There are four options that can be selected: allow, allow with return receipt, not allowed, lock message content. In addition, though not shown in this example, the sender can preferably also choose to, digitally “shred” or destroy the content based on a particular date or number of times viewed, and allow or disallow printing and/or copying/saving. With the “allow” option selected, a recipient is permitted to forward the content at will without any restrictions. In this case, no special rules are wrapped with the content. If the “allow with return receipt” option is selected, then when the content is forwarded, the original sender will receive notification of such an event. In this case, an appropriate rule (or code) is originally wrapped with the content such that when the recipient attempts to forward the content, local agent 130 automatically contacts control server 200, which in turn communicates with database servers 500 and notification servers 600 to effect the proper notification that the content has been forwarded. In this way, the original creator or sender can keep track of the content and, where appropriate, derive revenue from the dissemination thereof. Recall that the content remains encrypted even after it is sent to the recipient and, preferably, only local agent 130 can detect and decipher the rules that have been wrapped with the content. In view of the above, note that notification of a forwarding event can occur for the first forwarding event only and/or for all subsequent forwarding events.

Under the “not allowed” option, the recipient is forever blocked from forwarding the content. Finally, using the “lock message content” the recipient is blocked from editing the text in the message upon saving or forwarding.

Under the “Message Viewing” heading, the creator or sender can confine the viewing of the content to one time only. That is, the wrapper associated with the content preferably includes a rule (or code) that causes local agent 130 to deny any request to view the content after the content has been viewed once. Of course, the wrapper associated with the content, can also be designed so that local agent 130 is caused to automatically contact control server 200 each time the recipient attempts to view the content. In this way, it is possible to control how many times a recipient can view (or use) the content. Appropriate databases (not shown) can be arranged to keep track of how many times a user has viewed or accessed content, thereby enabling a content creator or sender the ability to track and monitor content use on a use-by-use basis. Alternatively, local agent 130 itself can comprise a counter that is incremented or decremented each time content is used. Likewise, a limit to how many times the content, or date/time frame the content can be viewed (or used) can be encoded with the wrapped content such that local agent 130 can control access to the content without having to access control server 200.

Those skilled in the art will appreciate that any of the foregoing dissemination control features can be set as default settings, thereby avoiding the selection process at each sending transaction.

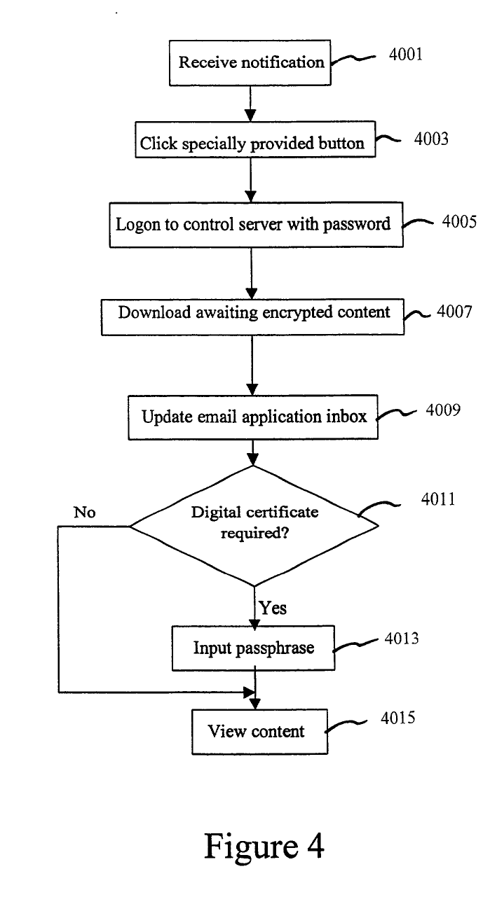

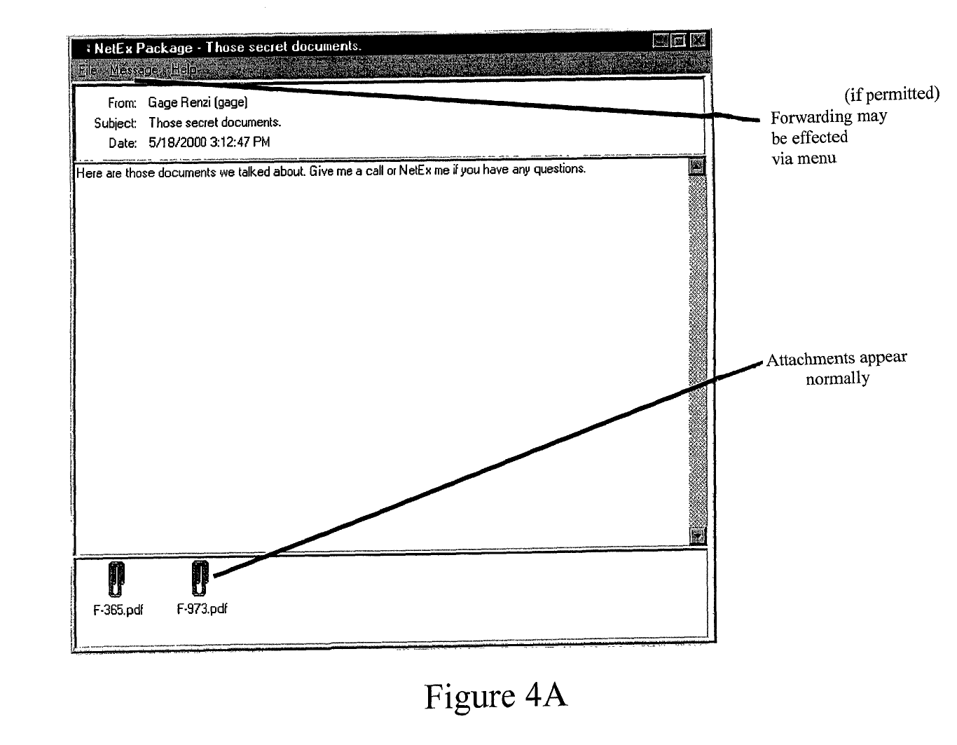

Receiving an email message (or other content) in accordance with the present invention is similar to sending the content in the first place, albeit the order of events is somewhat reversed. FIG. 4 depicts a flowchart that illustrates an exemplary process for receiving an encrypted email message in accordance with the present invention. After notification is received at Step 4001 that content (or a package) is awaiting retrieval, a user clicks on a special button, or menu option, provided within the graphical user interface of the content delivery system (i.e., LOTUS NOTES in the present example), Step 4003. This action causes local agent 130 to prompt the user for a password after which local agent accesses control server 200 at Step 4005. At Step 4007, control server 200 communicates with database servers 500 to fetch the awaiting package(s) and downloads that package(s) to the intended recipient. At Step 4009, local agent 130 causes the inbox of LOTUS NOTES to be updated with a new entry indicative of a received message. By clicking on this new entry, the user will either be permitted to immediately view the message, assuming no digital certificate is required by the dissemination rules wrapped with the content (Steps 4011 and 4015) or the user will have to supply a pass-phrase, biometric, or other authentication device, Step 4013, that authenticates that user as the true intended recipient. The viewer, or separate window, controlled by local agent 130 is then launched and the content is viewed (or used) by the user at Step 4015. FIG. 4A is an exemplary illustration of a local agent-controlled content viewing window in accordance with the present invention in which a menu can be accessed to effect content dissemination (forward, copy, etc.), assuming such dissemination is permitted. Also, as shown, attachments are easily accessed within the local-agent controlled window.

Encrypted Browser Content

The present invention can be used not only to encrypt data that is passed through an electronic messaging application such as LOTUS NOTES or MICROSOFT OUTLOOK, but also to pass browser content across the Internet. FIG. 1 also shows a web browser 900 that is preferably also associated, by conventional means, with electronic device 100. The browser is shown separately to emphasize that each application (e.g., messaging application, browser application, etc.), on its own, can exploit the principles of the present invention. As with the messaging application, an application specific interface (ASI) is provided to interact with the browser and pass information to and from a local agent that is also installed on the electronic device. Encrypted content is passed to and from the browser using key pairs and certificates in the same way as described above. Preferably local agent 130 is a common program that can be used with various applications. The ASI, on the other hand, is tailored to each application for which the PKI encryption techniques of the present invention are desired.

Applet Functioning as Local Agent

It is conceivable that some intended recipients of content that is encrypted in accordance with the present invention will not have, and may never load, a local agent/ASI in their electronic device. For example, corporations are often hesitant to allow their employees to import executable files inside the corporation's network firewall. In such cases, the present invention still provides a means by which the intended recipient can receive encrypted content that still carries the sender's desired dissemination rules.

More specifically, it can be determined from the user information database 510, or from the sender's local agent 130, that an intended recipient is not a registered user, i.e., the intended recipient does not have a local agent installed or loaded. So, instead of sending a notification to the intended recipient that a “package” is awaiting pick-up as described in the previous embodiments, control server 200 sends the recipient a hyperlink (URL) notification that when clicked, launches a web browser or the HTML features of an HTML-enabled email client. The server located at the said URL then downloads an applet, preferably coded in an operating system independent language such as JAVA. More often than not, corporations do not restrict such applets as long as the applets operate in within what is referred to, by those skilled in the art, as a “sandbox” of the browser (or HTML-enabled email client). The dynamically downloaded applet therefore loads and runs within the temporary cache of the browser and then reaches out (via, e.g., the Internet) to control server 200 and pulls down the appropriate file to be viewed. This file, of course, is still encrypted as it arrives within the applet. The applet thereafter decrypts the encrypted content and then acts as (or controls) a viewer for that content, whether it be a text, data or a graphic file.

Thus, it is possible to control the content that has been sent in the sense that the sender can still associate dissemination rules with the encrypted content and the dynamically downloaded applet controls how that content can be used, namely whether it can be selected (copied), printed, forwarded, or viewed more than once or within a selected time frame.

More specifically, a recipient is precluded from selecting (copying) or printing (outside what is allowed by the dissemination controls) what is seen within the viewer (assuming the sender so desires) since the actual image or the text that is being viewed is never stored outside of the browser sandbox; and thus no other portion of an operating system, such as MICROSOFT WINDOWS can gain external access to it. The browser receives the applet only and the applet itself fetches the content and views it. Of course, there may be a size limitation to the content that can be viewed at a given time which is determined, essentially, by the amount of RAM that has been dynamically assigned to the browser's “sandbox.” If the content is in fact too large for the “sandbox,” a message is preferably displayed for the recipient indicating that, in order to view the content, the recipient should allow dynamic download and install of the applet to run outside the “sandbox”. This message may instead ask the user to download a “true” local agent and associated ASI.

When the recipient has finished viewing the content, the browser is exited, thereby stopping the applet and, as a result, effectively removing the content from RAM as that area of RAM is re-allocated for some other use.

The process just described can also be modified to view email attachments that may, need to be viewed by an application other than an email client. Such an attachment might be a spreadsheet file or word processing document. However, the “life-of-content” control over the attachment would likely be defeated if the applet permitted the launching of the application that would be best to view the substance of the attachment. So, when it is determined that an email with an attachment is going to be sent to an unregistered user (i.e., one that does not have a local agent/ASI), the sender's local agent preferably takes a print image of the attachment and saves it as a multi-page TIFF, or other well-known similar type of image file (e.g. JPEG). As with the previously described embodiments, all of the foregoing is accomplished automatically, without the user's (sender's) intervention. It is this multi-page TIFF that is sent, encrypted with dissemination rules, to control server 200 and ultimately sent to the intended recipient via the dynamically downloaded applet. Accordingly, even without having a local agent/ASI, a sender can still control the dissemination of content that is being sent to recipients.

In an alternative embodiment, a sender sends a message/attachment as previously described. In this case, however, the recipient receives the email/attachment, where the encrypted content is inserted, and encoded, within an HTML attachment (of course, the particular format of the additional attachment is not critical to the invention). The email instructs the recipient to open the HTML attachment. When the attachment is opened a signed JAVA applet is downloaded from the control server 200, for example. In a corporate setting, a proxy server preferably caches the applet automatically until the applet is modified.

The applet thereafter decodes the encrypted content, and DRM/control rights and any “trial” private key embedded in the HTML file. The applet further decrypts the content based on available keys(s) or other DRM data in the document and opens a window within the browser (optionally based on a log file, see below for discussion of the use of log files).

In this alternative embodiment, memory buffer issues no longer apply as the encrypted content is already downloaded in an encrypted state via email. The digital rights management and log paradigm (described below) is thus preferably employed to enforce control options, with the exception that instead of a public/private key pair, a symmetric key pair is preferably used where that symmetric key is either appended into the encrypted content (instead of a private “trial” key) or securely downloaded to the applet based upon subsequent document opening and authorization. The matching symmetric key is preferably stored at another location, preferably at the same server as the applet, e.g., control server 200 or a server in communication therewith. The foregoing embodiment provides additional security and allows “on-the-fly” rule or DRM editing even after a package is sent.

Presentment Services

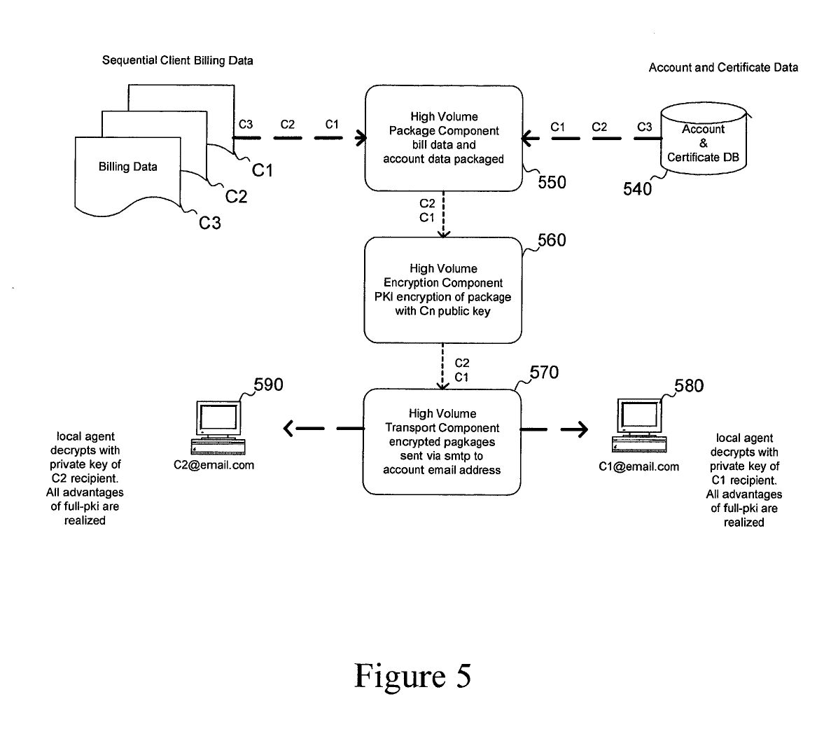

The present invention is also particularly suitable for encrypted “presentment” services. A presentment service might include, for example, electronically delivering statements or bills to a customer or subscriber and wherein the statement or bill is securely encrypted and only the intended recipient can view the contents thereof. Referring to FIG. 5, sequential client billing data C1, C2, C3 is transmitted to high volume package component 550. Component 550 also receives account, public key and certificate data C1, C2, C3 corresponding, respectively, to each client associated with the billing data. The client billing data and account and certificate data are then packaged together and passed to the high volume encryption component 560, which employs PKI-based encryption using the certificate packaged with the billing data and account data. The encrypted package (i.e., the encrypted bill or statement) is then passed to high volume transport component 570, from which the encrypted packages are sent via conventional SMTP to account email addresses. When each client receives an email, the user's local agent decrypts the statement or bill using the appropriate corresponding private key.

One advantage of the foregoing process is that instead of individual clients “hitting” a server belonging to the billing entity to retrieve their individual bills or account information on, e.g., the last day of a billing period, the billing entity instead “pushes” the bills or statements to each of the clients. Thus, the system and method of the present invention yields significant resource efficiencies Moreover, this is accomplished using full PKI-based encryption resulting in a robust presentment mechanism and process while avoiding significant numbers of hits on a web server that would normally occur if each of the clients were to try to “pull” his/her own bill or statement from that web server at the same time. This concept of course is not limited to the area of bill presentment, but is applicable to any secure sending of files where authentication of the key is used mainly for transport and audit trail reasons.

Digital Rights Management

While the present invention has been described thus far with respect to relatively static file types that are encrypted, namely, emails, attachments, data, bills and statements, the present invention is also particularly suited to implementing digital rights management (DRM) and control of data (such as streaming data) including the increasingly popular MP3 music file format. Of course, the discussion below is equally applicable to streaming video or any other standardized file format that may be employed to convey data from one party to another, wherein the sending party intends to keep control of or track of the data even after it has been sent to the second party (i.e., the recipient) or a third party (if forwarding is permitted) and so on.

In accordance with the present invention, customer (recipient) transactions and file transactions are permanently stored locally and encrypted into the relevant file. Offline DRM is also provided via the local agent, thereby opening up “super-distribution” opportunities as access rights are permanently enforced for both the original download site or user of the file, and any “trial” scenario presented as a user forwards the file without accessing a central server. Finally, as with the messaging (email) embodiments described above, from the user's perspective, an encrypted data file (e.g., an MP3 file) preferably retains its basic file structure such that a user's experience using the file remains familiar and the equipment used to view, listen to or otherwise use the encrypted data does not need to be modified, except for the addition of a local agent and ASI, which as described previously, can be appended to the content itself.

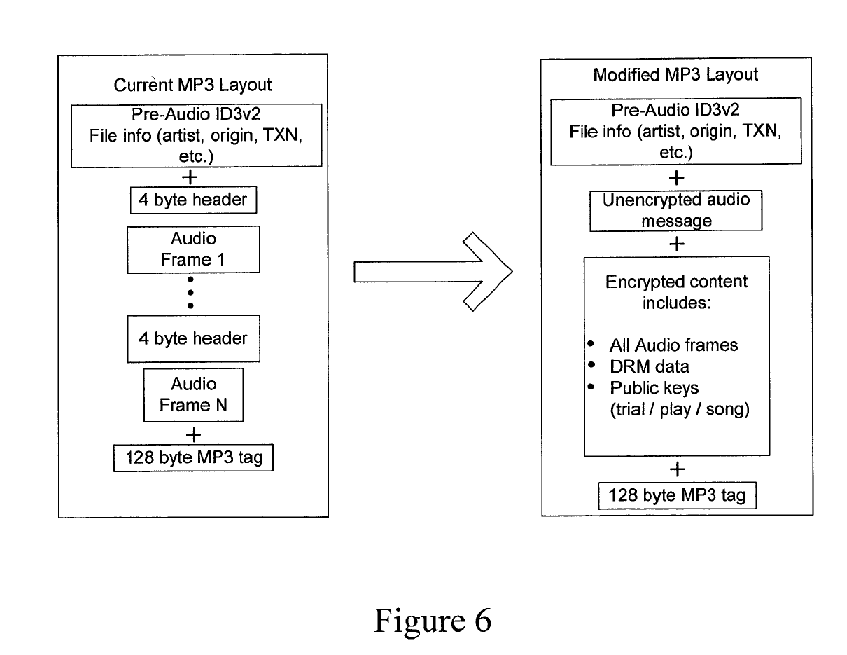

FIG. 6 illustrates how the standard or current MP3 file format may be modified in accordance with the present invention. The standard format is shown on the left side of the Figure while the modified format is shown on the right. As is readily seen, both file formats include the same pre-audio preamble and 128 byte MP3 tag. Accordingly, from the perspective of existing equipment that plays MP3 files, the “modified” MP3 file “looks” the same as a conventional MP3 file format in that the header and trailer of the modified file are identical to the header and trailer of a conventional file format. However, instead of including a plurality of conventional 4 byte header and audio frame combinations, the MP3 file format in accordance with the present invention includes an unencrypted audio message and encrypted data including all of the audio frames, DRM data and public keys necessary to decrypt the audio frames and play pre-recorded music.

The unencrypted audio message preferably includes a message notifying the would-be listener of the MP3 file that the music file is in an encrypted format and only authorized users are permitted to listen to the music. Instructions for obtaining the proper authorization are also preferably included in the message. For example, an audio tag stating “please go to the following web address to purchase access rights for this file” may be played Thus, the instructions might include accessing a web site and paying for the privilege of listening. Preferably, payment is not only a one time payment, but also may be for differing levels of access to the music file, as will be explained in more detail below.

As stated, the encrypted content includes all of the audio frames necessary to play the MP3 file. This encrypted data also includes DRM data including trial and purchased play rights and public keys associated with differing levels of access, namely, “trial,” “play” and “song.” Under trial play, the user is permitted to listen to the song/track once, or within a date/time window, and thereafter is precluded from listening without again obtaining the proper authorization. The “play” level access permits the user to play the song/track a predetermined number of times, e.g., five times. After the fifth play, the song/track remains encrypted until the user obtains the appropriate authorization by, for example, paying for such additional use. Finally, the “song” level access permits the user to buy the song/track whereby the user can have unlimited access to the song or track.

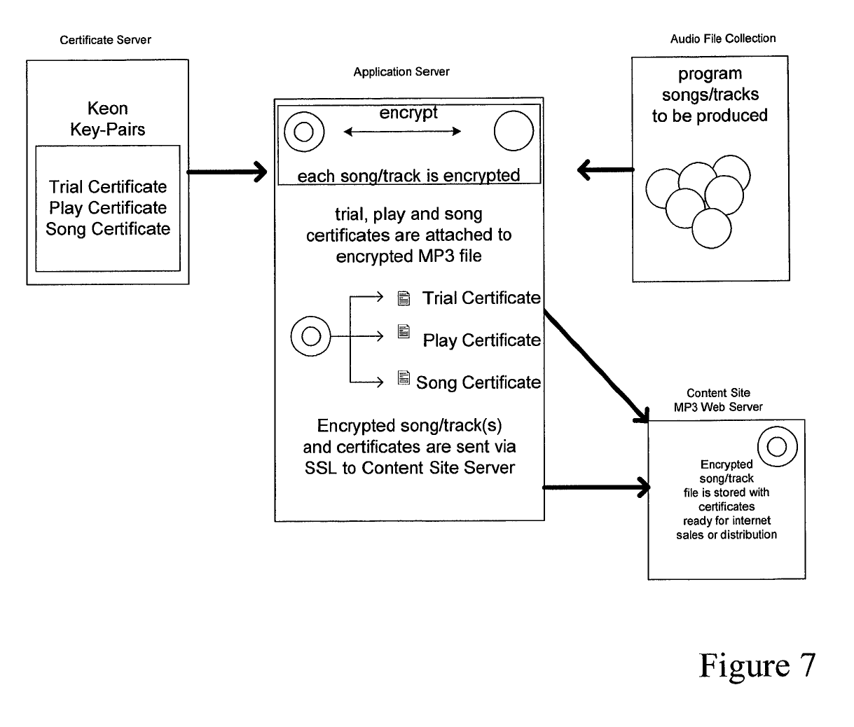

The modified MP3 file layout or format of FIG. 6 is preferably generated by the process depicted in FIG. 7. An application server is in communication with a certificate server and an audio file collection. The certificate server provides any CA key-pairs and certificates with the differing levels of access contemplated by the present invention. The audio file collection includes unencrypted songs and tracks that are desired to be encrypted before being released to the public. Encrypted content is “de-synchronized” so that non-PKI-enabled players will not mistake the encrypted content for real audio data. Thus a “header” portion of the encrypted MP3, or any other format, format is 100% compatible with the existing unencrypted version of the format.

Thus, as shown, the application server receives each song/track, encrypts it using the provided key-pairs and attaches the three certificates corresponding to the three possible levels of access. (Of course, the three levels of the access described are exemplary only and other types of controlled access can be implemented using the same principles discussed herein.) The encrypted song/track is depicted as being wrapped in a ring. Each encrypted song/track is then transferred, preferably via SSL connection for added security, to a content web site that serves up MP3 files in the conventional manner. Thus, encrypted songs/tracks are stored with certificates and are ready for sales or distribution via the Internet.

Thus, in accordance with the present invention, “intelligent” DRM digital certificates (trial, play and song certificates) are generated each time a song is encrypted, with multiple certificates generated per song depending on the number of rights sets desired, to encrypt and permanently bind customer identity at time of encryption, billing and other information including origin and trial policy to the file for both online and offline access control. Additionally, a trial portion of the content can be encrypted with the trial key, while the remaining portion of the content is encrypted using a play or song key. The MP3 files are encrypted using PKI digital certificates, whereby maximum security is ensured. Further, content is secured for direct download from the content site and secure payment authorization is available from the content site. Finally, permanent file tracking is provided such that online and offline audit trails and intelligent certificate data tracking is available. Offline audit trails are supplied in a digitally scrambled machine-specific “log” file (e.g. GUID-based) denoting the history of access to the content per machine or site, and digitally signed and authenticated by the local agent to prevent alteration. The log file may also be used to track usage and demographic data for periodic upload to a content provider, or with the local agent facilitate renewal of any advertising that may optionally be embedded into the original content, and overlay or “refresh” such content as appropriate. This advertising may, or may not, be in the same format as the content.

To play the thus-encrypted songs/tracks, an MP3 player preferably includes a local agent similar to that described previously with respect to the electronic messaging embodiment of the present invention. That is, the MP3 player, computer, or other streaming content platform (e.g. intranets, extranets, or the internet) onto which MP3 files are downloaded preferably includes a local agent that is able to decrypt encrypted audio files in accordance with the present invention, directly into the application or codec, all with limited or no user intervention.

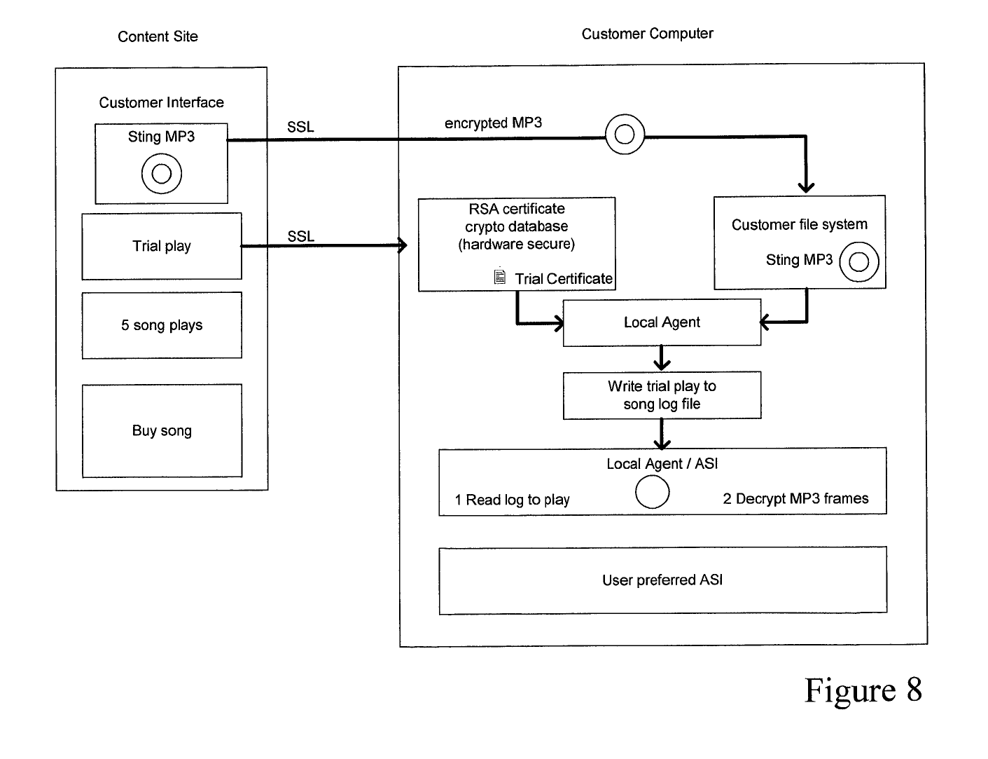

In some cases, however, the local agent may be appended to the content itself. More specifically and with reference to FIGS. 8-10, the unlocking or decryption process commences according to validation rules for purchase and/or trial access rights and the DRM certificate type. Preferably, “trial” play is used as a default if no “log” history is denoted. Customer and file profile data is validated utilizing public private key matching algorithms. Once authorization is secured to play the file using an MP3 player, the MP3 file is decrypted frame by frame from, e.g., a personal computer hard drive. That is, the local agent decrypts the frames using the appropriate key pairs in conjunction with the applicable certificate.

Referring to FIG. 8, the content site (which is the same as that shown in FIG. 7), upon request and/or payment, sends to a customer's computer the encrypted MP3 file (“Sting MP3”) and, in this case, a trial play certificate. The private key(s) unlocked from the digital certificate are downloaded to the user's local machine, and used to determine what rights set the user has access to. The Certificate is used to identify the rights set and match to the public key (or certificate) encoded in the song to the private key. Thus, all public keys (trial or play) are present in the song. Any matching private keys are preferably sent via SSL connection for added security, except the trial key that is preferably attached to the content. When the customer attempts to play the song, the MP3 file and available certificate(s) are identified by the local agent (that has been dynamically or previously installed in the customer's computer). The local agent, upon ascertaining that the certificate is for trial play only, writes to a song log file (which is not accessible by the customer) that the song is for trial play only, i.e., single use. The local agent thereafter reads the log file to determine if there are any further plays remaining in the song log file and, if so, decrypts the MP3 file frame by frame and passes the data to the customer's player.

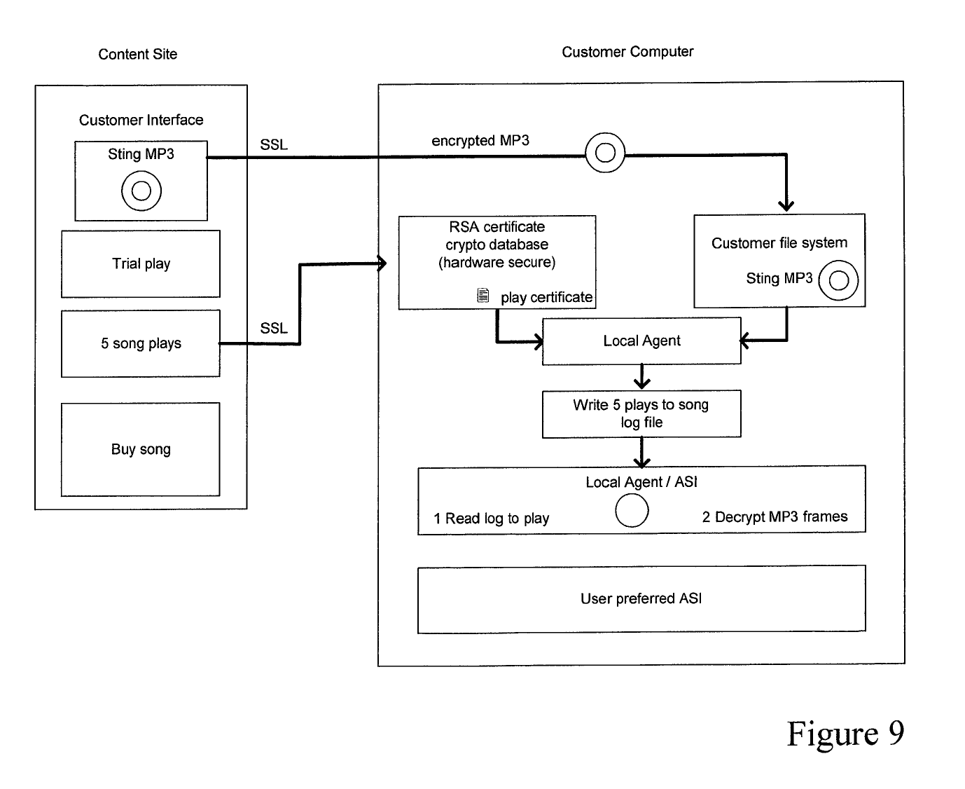

FIG. 9 is essentially identical to FIG. 8, except that in this case, a play certificate or key is provided by the content site. Here, the certificate indicates that the song can be played five times. When a user purchases the rights to a song, an appropriate play key is downloaded (and a certificate to cross-reference that private key). Accordingly, the local agent writes to the song log file that five playing of the song are permitted. Each time the song is played, the local agent increments or decrements a count in the song log file, so that the next time the customer attempts to play the song the local agent will know if the customer is entitled to further playings. The agent may optionally synchronize the local log file to the site of the original content provider or distributor.

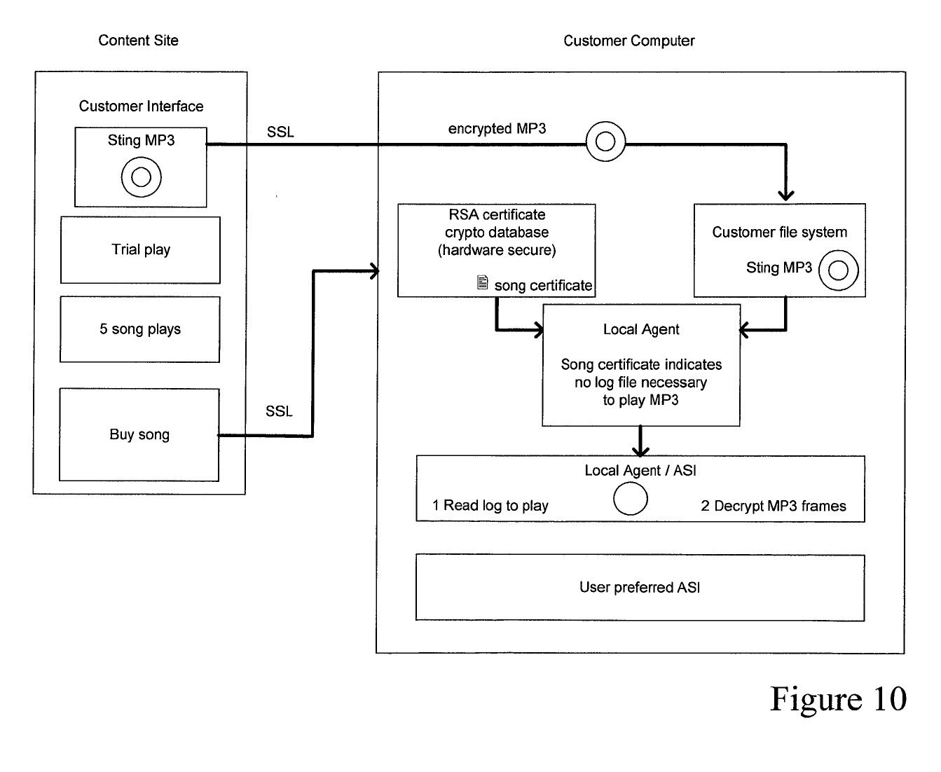

FIG. 10 is similar to the processes illustrated in FIGS. 8 and 9, except in this case the customer buys the song and is therefore entitled to play it as many times as he wishes. Accordingly, there is no need to check a song log file prior to decryption.

Thus, as is evident from the foregoing, the present invention provides systems and methods to automatically implement robust PKI-based encryption with respect to messaging applications, browsers, presentment services and digital rights management, and all with virtually no user intervention.

In describing the several embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

The foregoing disclosure of the several embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A system for implementing public key infrastructure (PKI) based encryption of content over an electronic network, comprising:
an encryption services component, the encryption services component generating key-pairs and providing certificate management services;
a PKI server, the PKI server being operable to function as at least one of a certificate authority and as a LDAP service provider;
a user information database;
a package database; and
a control server connected to the electronic network and operable to access the encryption services component, the PKI server, the user information database and the package database,
wherein the control server receives encrypted content in the form of a package,
wherein the package database stores the package,
wherein the package is sent back into the electronic network, and
wherein the package remains encrypted as it is passed through the control server and stored in the package database.

2. The system of claim 1, further comprising a notification server, wherein the notification server is operable to notify an intended recipient of the package that the package is awaiting pickup.

3. The system of claim 2, wherein the notification server is connected to at least one of an email server, a paging device, a netcall device, a facsimile machine and a voice line.

4. The system of claim 1, further comprising a transaction files database for tracking package traffic.

5. The system of claim 1, further comprising a roaming keys database.

6. The system of claim 1, further comprising an autoresponder, the autoresponder being operable to monitor a POP3 server and to notify the control server that an email sent in response to a notification server request was not successfully delivered.

7. The system of claim 1, further comprising an audit database.

8. The system of claim 1, wherein the control server is connected to the Internet.

9. The system of claim 8, wherein the control server is connected to the Internet via an SSL connection.

10. The system of claim 1, wherein the control server is operable to communicate with a local agent that is associated with an electronic device which itself is accessible via the electronic network.

11. The system of claim 1, wherein the content is at least one of an email message, an email attachment, a document, a business transaction, a graphic and streaming audio or video.

12. The system of claim 1, wherein the package comprises embedded dissemination rules that are not modifiable by a recipient of the package.

13. The system of claim 1, further comprising a certificate management component.

14. A secured content delivery system, comprising:
a control server, the control server being operable to receive encrypted content from an electronic network, the encrypted content having been encrypted using at least one public key and a private key, at least one public key and private key having previously been obtained via the control server;
a database server in communication with the control server, the database server being operable to store the encrypted content and store information indicative of a sender of the encrypted content and a recipient of the encrypted content; and
a notification server in communication with at least one of the control server and database server, the notification server being operable to notify the recipient of the encrypted content that the sender has sent encrypted content to the recipient,
wherein the public key is obtained without an express command from the sender.

15. The secured content delivery system of claim 14, further comprising a PKI server.

16. The secured content delivery system of claim 14, wherein the database server comprises at least one of a user information database, a transaction file database and an encrypted content database.

17. The secured content delivery system of claim 14, further comprising an encryption services module operable to generate key pairs and digital certificates that are compatible with a PKI.

18. The secured content delivery system of claim 14, wherein the control server receives the encrypted content from a local agent that is in communication with the electronic network.

19. The secured content delivery system of claim 14, wherein the control server communicates with a local agent to set up a communications link therebetween.

20. The secured content delivery system of claim 14, wherein the encrypted content is at least one of an email message, an email attachment, a document, a business transaction, a graphic and streaming audio or video.

21. The secured content delivery system of claim 14, wherein the electronic network is the Internet.

22. The secured content delivery system of claim 14, wherein the public key is obtained via an LDAP service.

23. In an electronic device having a messaging application capable of sending and receiving content over an electronic network, a system for sending and receiving encrypted content over the electronic network, comprising:
an application specific interface, the application specific interface being capable of interfacing with the messaging application to access and pass content and address information to and from the messaging application and update status information within the messaging application; and
a local agent in communication with the messaging application via the application specific interface, the local agent being operable to (i) receive unencrypted content from the messaging application, (ii) encrypt the content using a public/private key pair, and (iii) send encrypted content over the electronic network, the local agent further being operable to (iv) receive encrypted content from the electronic network, (v) launch a local agent-controlled window, (vi) decrypt the encrypted content using a private key, and (vii) display decrypted content in the local agent-controlled window.

24. The system of claim 23, wherein the application specific interface comprises software hooks providing access to the messaging application.

25. The system of claim 23, wherein the status information comprises entries in an inbox associated with the messaging application.

26. The system of claim 23, wherein the application specific interface is integrated with the local agent.

27. The system of claim 23, wherein the application specific interface is tailored to the messaging application.

28. The system of claim 23, wherein the local agent is operable to obtain the public key from a local register.

29. The system of claim 23, wherein the local agent is operable to automatically obtain the public key via a control server in communication with the electronic network.

30. The system of claim 23, wherein the local agent is operable to open the local agent-controlled window only after the local agent receives at least one of a passphrase and biometric authentication.

31. The system of claim 23, wherein at least one of the application specific interface and the local agent is operable to modify a graphical user interface of the messaging application.

32. The system of claim 23, wherein the local agent is operable to automatically preclude the viewing of the encrypted content in accordance with a dissemination rule wrapped with the encrypted content.

33. The system of claim 23, wherein the local agent is operable to wrap a dissemination rule with the encrypted content.

34. A system for implementing PKI-based encryption between a sender and a recipient, the system comprising:
a sender local agent associated with a sender electronic device, the sender electronic device being capable of connection to the Internet;
a recipient local agent associated with a recipient electronic device, the recipient electronic device being capable of connection to the Internet; and
a control server, the control server capable of being in communication with both the sender local agent and recipient local agent;
the sender local agent being operable to (i) receive content generated on the sender electronic device, (ii) generate a package of encrypted content using PKI-based encryption by obtaining at least one public key from one of the control server and a local registry, and (iii) send the package to the control server;
the control server being operable to receive the package from the sender local agent and transmit the package to the recipient local agent;
the recipient local agent being operable to (i) receive the package from the control server, (ii) launch a recipient local agent-controlled window, (iii) decrypt the encrypted content in the package, and (iv) display decrypted content within the recipient local agent-controlled window.

35. The system of claim 34, further comprising a package database for storing a plurality of packages.

36. The system of claim 34, further comprising a notification server component, the notification server component being operable to notify an intended recipient that a package is awaiting pickup.

37. The system of claim 34, wherein at least one of the sender local agent and the recipient local agent is an applet dynamically downloaded from the control server.

38. The system of claim 34, further comprising an application specific interface associated with at least one of the sender local agent and the recipient local agent.

39. The system of claim 34, further comprising a PKI server operable to at least one of generate public-private key-pairs and access keys via a LDAP service.

40. The system of claim 34, further comprising an audit database.

41. The system of claim 34, wherein the control server is operable to cause the package to be assigned a unique tracking number.

42. The system of claim 34, wherein the sender local agent is launched from within an email application.

43. The system of claim 34, wherein the sender local agent is operable to embed a content dissemination rule in the package.

44. The system of claim 43, wherein the dissemination rule comprises at least one of do not copy, do not print, do not forward and self-destruct.

45. The system of claim 34, wherein the content is at least one of an email, an email attachment, a data file, a music file, and an XML file.

46. The system of claim 34, wherein at least one of the sender local agent and recipient local agent is operating system independent.

47. The system of claim 34, wherein the control server controls at least one of security, authentication, tracking, confirmation and archiving.

48. The system of claim 36, wherein notification is provided by at least one of voice, fax pager and email.

49. The system of claim 34, wherein at least one of the sender local agent and recipient local agent is dynamically downloaded from the control server.

50. A system for presenting information, comprising:
a high volume package component operable to receive sequential data files and operable to associate the data files with a plurality of account and certificate data, respectively, to create a plurality of packages;
a high volume encryption component operable to implement PKI-based encryption on each of the packages and generate encrypted packages using the certificate data; and
a high volume transport component operable to receive the encrypted packages and send each package to its intended recipient based on the account data.

51. The system of claim 50, wherein the data files represent at least one of bills and statements.

52. The system of claim 50, wherein each recipient comprises a local agent operable to receive and decrypt the encrypted package.

53. The system of claim 50, wherein the account data includes an email address.

54. The system of claim 50, wherein the high volume transport component comprises an email server.

55. The system of claim 50, wherein the high volume encryption component encrypts the packages using a public key associated with the recipient.

56. A method of sending content using an email client, the content being encrypted in accordance with PKI—based encryption, the method comprising the steps of:
(a) creating the content;
(b) launching a local agent associated with the email client;
(c) passing the content and an address of a recipient to the local agent;
(d) selecting at least one dissemination rule for the content;
(e) obtaining a public key associated with the recipient;
(f) encrypting the content using the public key and a private key;
(g) wrapping the encrypted content with the at least one dissemination rule thereby creating a package;
(h) transmitting the package to a control server which is operable to forward the package to the recipient.

57. The method of claim 56, wherein the content is at least one of an email message, an email attachment, a document, a business transaction, a graphic and streaming audio or video.

58. The method of claim 56, wherein the local agent comprises an application specific interface that provides an interface to the email client.

59. The method of claim 56, wherein the local agent is launched in response to user input.

60. The method of claim 56, wherein the dissemination rule comprises at least one of do not copy, do not print, do not forward and self-destruct.

61. The method of claim 56, further comprising automatically obtaining the public key of the recipient by accessing the control server.

62. The method of claim 61, wherein the control server accesses at least one of a certificate authority server and a LDAP directory service.

63. The method of claim 56, further comprising notifying the recipient of an awaiting package.

64. The method of claim 63, wherein the recipient is notified suing at least one of voice, fax, email and pager.

65. The method of claim 56, wherein the control server stores the package until the package is requested by the recipient.

66. The method of claim 56, wherein the control server causes a unique tracking number to be assigned to the package.

67. The method of claim 56, wherein the local agent communicates automatically with the control server.

68. A method of receiving content using an email client, the content being encrypted in accordance with PKI—based encryption, the method comprising the steps of:
(a) receiving a notification that a package is awaiting downloading, the package comprising encrypted content and at least one dissemination rule;
(b) launching a local agent associated with the email client;
(c) logging on to a control server via the local agent;
(d) downloading the package;
(e) launching a local agent-controlled window; and
(d) decrypting the content within the window in accordance with the dissemination rule.

69. The method of claim 68, wherein the notification is received via at least one of voice, fax, email and pager.

70. The method of claim 68, wherein the content is at least one of an email, an email attachment, a business transaction, a document and a graphics file.

71. The method of claim 68, wherein the local agent communicates with the email client via an application specific interface.

72. The method of claim 68, wherein the local agent is an applet dynamically downloaded via the control server.

73. The method of claim 72, wherein the package is downloaded and stored within the memory allocation of the applet.

74. The method of claim 68, wherein the local agent communicates with the control server to cause the package to be downloaded.

75. The method of claim 68, wherein the encrypted content is stored in the same encrypted form even after being viewed.

76. The method of claim 68, wherein the local agent communicates with the control server before the package is downloaded to authenticate the recipient.

77. A method of automatically implementing PKI-based encryption between a sender and a recipient, the method comprising the steps of:
(a) associating a sender local agent with a sender electronic device, the sender electronic device being capable of connection to the Internet;
(b) associating a recipient local agent with a recipient electronic device, the recipient electronic device being capable of connection to the Internet;
(c) providing a control server, the control server capable of being in communication with both the sender local agent and recipient local agent;
(d) receiving, by the sender local agent, content generated on the sender electronic device;
(e) generating, by the sender local agent, a package of encrypted content using PKI-based encryption by obtaining at least one public key from one of the control server and a local register;
(f) sending the package to the control server;
(g) receiving the package at the control server and notifying the recipient of an awaiting package;
(h) receiving, by the recipient local agent, the package from the control server;
(i) launching a recipient local agent-controlled window;
(j) decrypting the encrypted content in the package; and
(k) displaying the decrypted content within the recipient local agent-controlled window.

78. The method of claim 77, further comprising storing the package in a database accessible to the control server.

79. The method of claim 77, further comprising dynamically downloading at least one of the sender local agent and recipient local agent as an applet from the control server.

80. The method of claim 77, further comprising providing an application specific interface associated with at least one of the sender local agent and the recipient local agent.

81. The method of claim 77, further comprising providing a PKI server operable to at least one of generate public-private key-pairs and access keys via a LDAP service.

82. The method of claim 77, further comprising providing an audit database.

83. The method of claim 77, further comprising assigning a unique tracking number to the package.

84. The method of claim 77, further comprising launching the sender local agent from within an email application.

85. The method of claim 77, further comprising embedding at least one dissemination rule in the package.

86. The method of claim 85, wherein the dissemination rule includes at least one of do not copy, do not print, do not forward and self-destruct.

87. The method of claim 77, wherein the content is at least one of an email, an email attachment, a streaming media file, and an XML file.

88. The method of claim 77, wherein at least one of the sender local agent and recipient local agent is operating system independent.

89. The method of claim 77, further comprising controlling at least one of security, authentication, tracking, confirmation and archiving of the package.

90. A digital audio file, comprising:
a pre-audio identification portion;
an unencrypted audio message;
an encrypted content portion; and
a tag portion.

91. The digital audio file of claim 90, wherein the audio is formatted in accordance with the MP3 standard.

92. The digital audio file of claim 90, wherein the unencrypted audio message includes a notification to a listener regarding use of the digital audio file.

93. The digital audio file of claim 92, wherein the unencrypted audio message provides a listener with instruction regarding how to obtain listening rights to the audio file.

93. The digital audio file of claim 90, wherein the encrypted content portion comprises audio frames and at least one of digital rights management (DRM) data and public keys.

94. The digital audio file of claim 93, wherein the DRM data comprises at least one of a trial key, a play key, and a song key.

95. A secured content delivery system, comprising:
a control server, the control server operable to receive encrypted content from an electronic network, the encrypted content having been encrypted using an encryption scheme wherein data necessary to implement the encryption scheme having previously been obtained from the control server;
a database server in communication with the control server, the database server being operable to store the encrypted content and store information indicative of a sender of the encrypted content and an intended recipient of the encrypted content; and
a notification server in communication with at least one of the control server and database server, the notification server being operable to notify the intended recipient that the sender has sent encrypted content,
wherein the data necessary to implement the encryption scheme is obtained without an express command from the sender.

96. A method of automatically implementing encryption between a sender and a recipient, the method comprising the steps of:
(a) associating a sender local agent with a sender electronic device, the sender electronic device being capable of connection to the Internet;
(b) associating a recipient local agent with a recipient electronic device, the recipient electronic device being capable of connection to the Internet;
(c) providing a control server, the control server being in communication with both the sender local agent and recipient local agent, but not necessarily at the same time;
(d) receiving, by the sender local agent, content generated on the sender electronic device;
(e) generating, by the sender local agent, a package of encrypted content using an encryption scheme by obtaining data necessary to implement the encryption scheme from one of the control server and a local register;
(f) sending the package to the control server;
(g) receiving the package at the control server and notifying the recipient of an awaiting package;
(h) receiving, by the recipient local agent, the package from the control server;
(i) launching a recipient local agent-controlled window;
(j) decrypting the encrypted content in the package; and
(k) displaying the decrypted content within the recipient local agent-controlled window.

97. The method of claim 96, further comprising storing the package in a database accessible to the control server.

98. The method of claim 96, further comprising dynamically downloading at least one of the sender local agent and recipient local agent as an applet from the control server.

99. The method of claim 96, further comprising providing an application specific interface associated with at least one of the sender local agent and the recipient local agent.

100. The method of claim 96, wherein the encryption scheme is PKI-based encryption and wherein the method further comprises providing a PKI server operable to at least one of generate public-private key-pairs and access keys via a LDAP service.

101. The method of claim 96, further comprising providing an audit database.

102. The method of claim 96, further comprising assigning a unique tracking number to the package.

103. The method of claim 96, further comprising launching the sender local agent from within an email application.

104. The method of claim 96, further comprising embedding at least one dissemination rule in the package.

105. The method of claim 104, wherein the dissemination rule includes at least one of do not copy, do not print, do not forward and self-destruct.

106. The method of claim 96, wherein the content is at least one of an email, an email attachment, a streaming media file, and an XML file.

107. The method of claim 96, wherein at least one of the sender local agent and recipient local agent is operating system independent.

108. The method of claim 96, further comprising controlling at least one of security, authentication, tracking, confirmation and archiving of the package.
